(19) United States
(12) Patent Application Publication
(10) Pub. No.: US 2023/0301863 A1
(43) Pub. Date: Sep. 28, 2023

(54) MATTRESS AND CONTROL METHOD THEREOF

(71) Applicant: HALCYON INC., Seoul (KR)

(72) Inventor: Ji Sun LEE, Seongnam-si (KR)

(73) Assignee: HALCYON INC., Seoul (KR)

(21) Appl. No.: 17/634,240

(22) PCT Filed: Jul. 15, 2021
(86) PCT No.: PCT/KR2021/009123

§ 371 Date: Feb. 10, 2022

(51) Int. Cl. A61H 1/00; G05D 19/02; A47C 21/00; A61G 7/057

(52) U.S. Cl. CPC A61H 1/005; G05D 19/02; A47C 21/006; A61G 7/057; A61H 2201/0146; A61H 2230/625; A61H 2201/501; A61H 2201/5048; A61H 2201/5005

(57) ABSTRACT

Disclosed is a mattress control method, comprising the steps of obtaining biometric information of a user, outputting vibration based on a sound source according to a comparison result between the biometric information and a threshold value, and transmitting at least one of the biometric information, the threshold value, and mattress control information to an external controller, wherein the biometric information includes at least immobility state duration information as sub-information, the threshold value includes at least an immobility state duration threshold value, and the vibration is output when the immobility state duration information exceeds the immobility state duration threshold value, and is output based on external control information when the external control information is received from the external controller.

### TECHNICAL FIELD

The present invention relates to a mattress and a control method thereof.

### BACKGROUND ART

As the life expectancy of humans increases, the proportion of the elderly in the total population is gradually increasing. Among the elderly, those with reduced mobility (hereinafter, referred to as the “elderly with reduced mobility”) spend a long time lying in bed or hospital bed. Elderly people with mobility impairments are more likely to develop bedsores in their bodies because they have little or no activity. In order to prevent the occurrence of bedsores, it is necessary to frequently change the bed contact surface of the elderly with mobility impairment by applying external force by protective personnel, (for example, guardians, caregivers, medical personnel, etc.). Since the protective personnel judge the condition based on the senses (visual observation, memory, etc.) and take corresponding measures, the judgment may be inaccurate or the measures may be inappropriate. In addition, care through protective personnel is expensive. Therefore, there is a need for a method that has a high effect of preventing bedsores for the elderly and can reduce costs.

An air-filled mattress, that is, an air mattress is one of the representative devices for preventing bedsores. A conventional air mattress applies an external force to the body of an elderly person with reduced mobility through an air grid, alternating flotation, or tilting method. Although the above methods temporarily change the contact surface between the disabled elderly person and the bed, it is highly likely to cause a hammock phenomenon. In addition, since the conventional method only adjusts the vertical position of a user to a certain extent, within a relatively short time after the bedsore prevention operation is stopped, the bedsore prevention operation is required again for the user's body part where the bedsore prevention operation was performed. In other words, the conventional mattress has a relatively short cycle of operation to prevent bedsore. This may cause discomfort to the user from using the mattress, consume a lot of power, and shorten the service life of the mattress. In addition, the conventional mattress is used in places such as home or hospital, and it is difficult to recognize the operation status of the mattress or control the mattress when a guardian is in a remote place.

### DISCLOSURE

### Technical Problem

Accordingly, the present invention has been made in an effort to solve the above-mentioned problems occurring in the prior arts, and it is an object of the present invention to provide a mattress and a control method thereof for preventing a hammock phenomenon.

Also disclosed are a mattress and a control method thereof, in which a long operation period is performed for preventing bedsores.

Also disclosed are a mattress and a control method thereof, in which bedsores can be effectively prevented.

Also disclosed are a mattress and a control method thereof, in which a guardian can realize and control operating status from a remote place.

### Technical Solution

To achieve the above objects, the present invention provides a mattress control method, including the steps of obtaining biometric information of a user, outputting vibration based on a sound source according to a comparison result between the biometric information and a threshold value, and transmitting at least one of the biometric information, the threshold value, and mattress control information to an external controller, wherein the biometric information includes at least immobility state duration information as sub-information, and the threshold value includes at least an immobility state duration threshold value, and wherein the vibration is output when the immobility state duration information exceeds the immobility state duration threshold value, and is output based on external control information when the external control information is received from the external controller.

The outputting step includes the step of outputting a sound based on the sound source, and the sound is output when the immobility state duration information exceeds the immobility state duration threshold value.

The sound source is determined based on the beats per minute BPM of the sound source and the biometric information.

The biometric information further includes sleep biometric information, and sound output is stopped when it is determined that a user is in a sleep state based on the sleep biometric information.

A mattress includes a sensor for obtaining biometric information of a user, a control unit for controlling a vibration unit according to a comparison result between the biometric information and a threshold value so that vibration is output based on a sound source, and a communication interface for transmitting at least one of the biometric information, the threshold value, and mattress control information to an external controller, wherein the biometric information includes at least immobility state duration information as sub-information, and the threshold value includes at least an immobility state duration threshold value, and wherein the vibration is output when the immobility state duration information exceeds the immobility state duration threshold value, and is output based on external control information when the external control information is received from the external controller.

The control unit is configured to further control a speaker so that the speaker outputs a sound based on the sound source, and the sound is output when the immobility state duration information exceeds the immobility state duration threshold value.

The sound source is determined based on the beats per minute BPM of the sound source and the biometric information.

The biometric information further includes sleep biometric information, and the control unit stops sound output when it is determined that a user is in a sleep state based on the sleep biometric information.

### Advantageous Effects

The mattress and its control method according to the present invention prevent a hammock phenomenon.

The mattress and its control method according to the present invention have a long operation period for preventing bedsores.

The mattress and its control method according to the present invention can effectively prevent bedsore.

The mattress and its control method according to the present invention allow a guardian to realize and control operating status from a remote place.

### DESCRIPTION OF DRAWINGS

FIG. 1 is a flowchart of a mattress control method according to an embodiment of the present invention.

FIG. 2 shows biometric information and threshold values of a mattress according to an embodiment of the present invention, and

FIG. 3 is a block diagram of a mattress according to an embodiment of the present invention.

### MODE FOR INVENTION

In order to make the objects, technical solutions and advantages of the present invention more clear, exemplary embodiments according to the present invention are described in detail below with reference to the accompanying drawings. Obviously, the described embodiments are not all embodiments of the present invention, but only some embodiments of the present invention, and it should be understood that the present invention is not limited by the exemplary embodiments described herein. Based on the embodiments of the present invention described herein, all other embodiments obtained by a person skilled in the art without any creative effort input fall within the protection scope of the present invention.

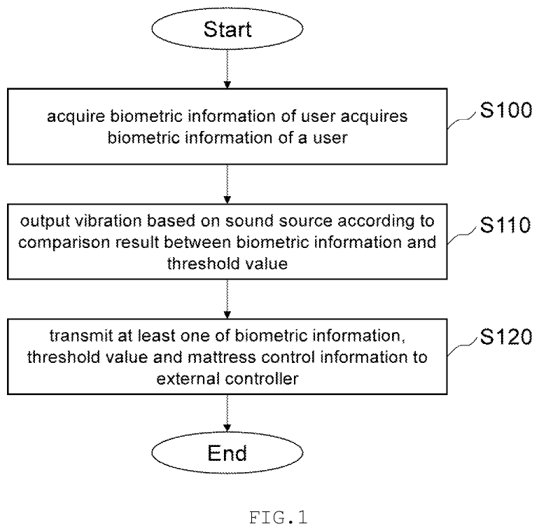

FIG. 1 is a flowchart of a mattress control method according to an embodiment of the present invention.

A mattress acquires biometric information of a user (S100).

An air-type mattress filled with air may be used as a mattress 100 of the present application, but is not limited thereto, and any type of mattress capable of generating vibration through a medium may be used as the mattress 100 of the present application. Therefore, not only a liquid-type mattress such as a water mattress, etc., but also a solid mattress of which interior is composed of synthetic resin, fibers, springs, etc. may be used as the mattress 100 of the present application. Herein, a user refers to a person who is provided with vibration or sound through the mattress 100. The user mainly includes, but is not limited to, a person with reduced mobility such as the elderly, patients, children, and the disabled.

The biometric information is obtained through a sensor 110. The sensor 110 may include a pressure sensor, a temperature sensor, an infrared sensor, an ultrasonic sensor, a vein sensor, a heart rate sensor, a respiration sensor, a bio-noise sensor, etc. used to acquire various kinds of biometric information. A high-sensitivity semiconductor-type composite sensor may be employed as the sensor 110. Such a high-sensitivity semiconductor-type composite sensor has high reliability and stability and easy maintenance compared to conventional metal foil load cell sensors. The mattress 100 may perform correction and noise filtering on the information obtained through the sensor 110.

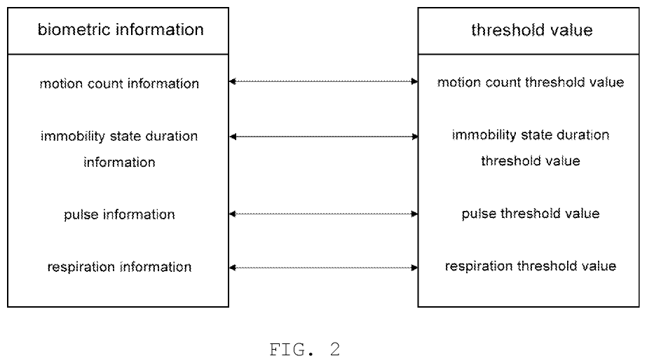

The biometric information may include at least immobility state duration information as sub-information, and a threshold value may include at least one or more lower threshold values respectively corresponding to the sub-information of the biometric information. Hereinafter, the relationship between the biometric information and the threshold value and the relationship between the sub-information of the biometric information and the lower threshold value will be described in detail with reference to FIG. 2.

The immobility state duration information means the duration from the time when the last motion of a user is sensed until a next motion is detected. Since bedsore occurs when there is no operation for a long time, the immobility state duration information is one of the main parameters used to predict bedsore occurrence. In order to obtain the immobility state duration information, means such as a pressure sensor, an infrared sensor, a noise sensor, etc. may be used, but is not limited thereto.

In another embodiment, the biometric information may include motion count information and the threshold value may include a motion count threshold value (not shown). Such a motion count information means the number of times that the motion of a user is sensed for a certain period of time. The mattress 100 may be configured to output vibration based on a sound source when the motion count information is less than a motion count threshold value.

The mattress outputs vibration based on the sound source according to the comparison result between the biometric information and the threshold value (S110).

In an embodiment, the mattress 100 may compare immobility state duration information among the obtained biometric information with an immobility state duration threshold value. When immobility state duration information M exceeds an immobility state duration threshold value N, the mattress 100 outputs vibration. Herein, the immobility state duration threshold value N means the shortest time that the bedsore is expected to occur.

In an example, the immobility state duration threshold value N may be an input value received from the outside (for example, a user himself, a caregiver, or a guardian) of the mattress 100. In this case, the input value may be input through an input device, including an external controller, connected to the mattress 100 through wired/wireless communications.

In another example, the immobility state duration threshold value N may be a value received from an external DB in which medical related information is stored. For example, the external DB may be a DB operated by bedsore research societies, university hospitals, government health organizations, and the like. The immobility state duration threshold value N determined by the external DB has high reliability.

In a further example, the immobility state duration threshold value N may be a value derived from the analysis result of the bedsore-related data of a user. The blood flow rate and blood pressure of a user are one of the parameters that affect whether bedsore occurs. The blood flow rate and blood pressure of a user may vary depending on age, gender, health status, and the like. Therefore, a duration required for a bedsore to develop may also be different for each user. If the same immobility state duration threshold value N is applied to all users, it may be possible to output unnecessary vibrations to patients who do not have bedsores for a relatively long time. In addition, for patients who develop bedsore in a relatively short time, the purpose of preventing bedsore cannot be achieved. By setting a different immobility state duration threshold value N for each user, it is possible to provide an optimal bedsore prevention function to all users.

The vibration based on a sound source means vibration corresponding to the properties of a sound source such as melody, beat time, volume, key, etc. The present invention outputs vibration based on a sound source, unlike mechanically repeated vibration, so that it is possible to solve the monotony of vibration and provide pleasure to a user. Herein, the sound source may be determined based on beats per minute BPM of the sound source and the biometric information. For example, the mattress 100 may be configured to select a sound source having high BPM as the immobility state duration increases. In other words, a sound source with higher BMP is selected as a user moves less, thereby effectively preventing bedsores from occurring.

In another embodiment, the sound source may be selected by a user or protective personnel. When the sound source is selected by a user, the user's preference is reflected so that the user's satisfaction is improved. When the sound source is selected by the protective personnel, the prevention of bedsores can be improved by mainly selecting a sound source with high BPM.

In still another embodiment, the sound source may be selected based on the sound source selection history of a user. Accordingly, the sound source may be the one which has been most frequently selected as a sound source that is the basis of vibration.

In a further embodiment, the sound source may be selected to have a high similarity to a sound source that was selected just before in terms of melody, beat time, volume, key, and the like. Therefore, it is possible to continuously provide vibration with the same or similar strength while minimizing the feeling of monotony or fatigue perceived by a user.

In a still further embodiment, the sound source may be composed of a series of sound sources of which BPM gradually decreases. Therefore, it is possible to minimize the effect of vibration on a user's rest while preventing the occurrence of bedsores.

Since the mattress 100 of the present invention uses the principle of vibrating according to a sound source, it provides a scrub massage effect. The mattress 100 using the air grid, alternating flotation, or tilting methods only pushes a user by using the principle of pneumatic expansion, failing to provide a scrub massage effect. Meanwhile, according to the present invention, the mattress 100 only transmits vibration and the shape of the mattress 100 is maintained, so that it provides a comfortable use experience to a user. In order to maintain the shape of the mattress 100, a large amount of fiber thread shanks may be provided inside the mattress 100 so as to connect the top and bottom surfaces of the mattress 100. Since the shape of the mattress 100 using the air grid, alternating flotation, or tilting methods changes during operation, the degree of comfort is relatively low.

Although not shown, the mattress 100 may be further configured to output sound based on a sound source that is the basis of vibration. Herein, the control information of the mattress 100 may further include at least one of information on the need for sound output, information on whether sound is currently being output, information on a sound source that is the basis of the output sound or a sound source list, duration information of the sound being output, recommended sound output duration information, sound volume information, speaker power supply status information, and the like.

To this end, a speaker may be further installed on one side of the mattress 100, wherein at least one or more speakers may be provided and may be disposed in a position close to ears of a user. Herein, the sound may be output when immobility state duration information exceeds an immobility state duration threshold value. Compared to the case in which only vibration is output, when both vibration and sound are output together, the user's sensitivity to the vibration is relatively low and thus the user experience is improved, since both the vibration and sound are based on a same sound source so that the user does not feel the vibration well due to the sound. The mattress 100 may further include an amplifier to amplify the vibration or sound as needed (not shown).

In an embodiment, vibration and sound may be output synchronously or asynchronously. When vibration and sound are output synchronously, side effects such as dizziness that can be caused by asynchronous mixing can be minimized.

In another embodiment, vibration and sound may be output based on different sound sources. In this case, it is possible to output vibration based on a sound source with high BPM, for example, a rap or hip-hop sound source so as to maximize the effect of preventing bedsores, while outputting sound based on a sound source with low BPM, for example, a classical sound source so as to achieve mental stability of a user.

In still another embodiment, when sound is output in a stereo type, vibration may also be output in a stereo type. To this end, the mattress 100 may include at least two speakers and at least two vibration units 120.

The mattress transmits at least one of the biometric information, the threshold value, and the mattress control information to the external controller (S120).

The control information may include at least one of information on the need for vibration output, information on whether vibration is currently being output, information on a sound source that is the basis of the output vibration or a sound source list, duration information of the vibration being output, recommended vibration output duration information, vibration output intensity information, power supply status information of the vibration unit 120, and the like.

The external controller 200 (not shown) refers to a device that is connected to the mattress 100 through wired/wireless communications and controls the mattress 100 remotely. The external controller 200 may include the mattress 100 and a variety of devices such as mobile phones, laptops, tablet PCs, desktops, smart watches, smart glasses, smart bands, head mounted devices HMDs, TVs, and PDAs. The external controller 200 can be controlled by a user or protective personnel. When a user uses the external controller 200, vibration and/or sound can be output based on the most preferred sound source of the user. Protective personnel can take care of a user from a remote place by using the external controller 200.

The external controller 200 may output the biometric information, the threshold value, and the control information visually or audibly. The external controller 200 may receive external control information from the outside through an input unit such as a microphone, a button, a touch screen, etc.) and transmit the external control information to the mattress 100. For example, when biometric information does not exceed a threshold value but has a numerical value close to the threshold value, protective personnel may input external control information to the external controller 200 so as to control the mattress 100 so that vibration is output. In this case, the threshold value may be updated with the biometric information at the time when an external control signal is received.

When the mattress 100 receives the external control information from the external controller 200, the mattress 100 may output vibration based on the external control information. This means that, in terms of triggering a vibration output, the priority of the external control information is higher than the priority of the comparison result between the biometric information and the threshold value. In this case, even if it is determined that there is no need to output vibration according to the comparison result between the biometric information and the threshold value, vibration may be output according to the external control information. To the contrary, the priority of the comparison result between the biometric information and the threshold value may be set higher than the priority of the external control information. The external control information may include at least one of vibration or sound output information, vibration or sound interruption information, vibration or sound duration setting information, and information on a sound source that is the basis of vibration or sound.

FIG. 2 shows biometric information and threshold values of a mattress according to an embodiment of the present invention.

The threshold value may include lower threshold values respectively corresponding to sub-information of biometric information. Referring to FIG. 2, biometric information may include motion count information, immobility state duration information, pulse information, respiration information, and the like. In this case, the threshold value may include a motion count threshold value, an immobility state duration threshold value, a pulse threshold value, a respiration threshold value, and the like. Although not shown in FIG. 2, biometric information may further include body temperature information, snoring information, teeth grinding information, and the like. Herein, the threshold value may be a value preset by a user or protective personnel, or a value input from the outside.

Among the sub-information, pulse information, respiration information, body temperature information, snoring information, teeth grinding information, etc. may be used as sleep biometric information. Specifically, the pulse is lowered, the respiratory rate is reduced, and the body temperature is lowered during sleep compared to those during activity. Therefore, when the pulse information is less than a pulse threshold value, the respiration information is less than a respiratory threshold value, or the body temperature information is less than a body temperature threshold value, it may be determined that a user is in a sleep state. In addition, when the snoring information exceeds a snoring threshold value or the teeth grinding information exceeds a teeth grinding threshold value, it may be determined that a user is in a sleep state. Since sound output may disturb the sleep of a user, sound output may be stopped when it is determined that the user is in a sleep state. Whether a user is in a sleeping state may also be determined through the amount of light, illuminance, and time. The mattress 100 may further include a light sensor 110 so as to determine whether a user is in a sleeping state based on the amount of light or illuminance. When it is determined that a user is in a sleep state, the sound source that is the basis of vibration may be selected such that the BPM thereof is less than a sleep BPM threshold value. Accordingly, it is possible to prevent the occurrence of bedsores and, at the same time, improve the quality of the user's sleep.

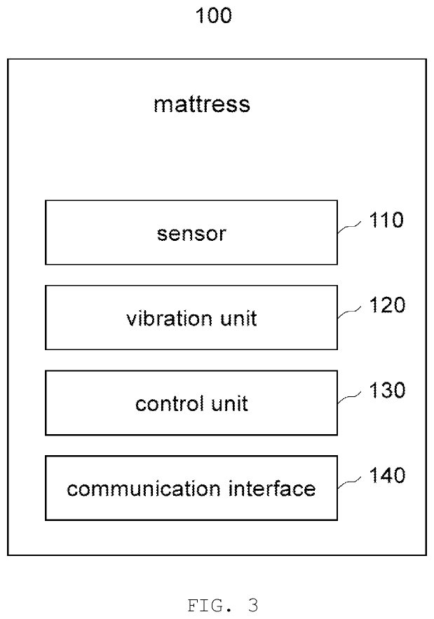

FIG. 3 is a block diagram of a mattress according to an embodiment of the present invention.

Referring to FIG. 3, the mattress 100 includes the sensor 110, the vibration unit 120, a control unit 130, and a communication interface 140. The sensor 110 acquires the biometric information of a user. The control unit 130 controls the vibration unit 120 according to the comparison result between the biometric information and the threshold value and outputs vibration based on the sound source. The communication interface 140 transmits at least one of the biometric information, the threshold value, and the control information of the mattress 100 to the external controller. Although not shown, the mattress 100 may further include a speaker as a means for outputting sound based on the sound source.

It should be noted that the foregoing embodiments illustrate the present invention rather than limit it, and that those skilled in the art can design alternative embodiments without departing from the scope of the appended claims. In the claims, any reference signs placed between parentheses are to be construed as not limiting the claims. The word “comprising” or “including” does not exclude the presence of elements or steps not listed in the claims. The word “a” or “an” placed before an element does not exclude the presence of multiple such elements. The present invention may be implemented by means of hardware comprising several distinct elements and a suitably programmed computer. In a claim enumerating units of some devices, some of these devices may be embodied in the same hardware item. The use of words such as first, second, and third does not imply order. These words can be interpreted as names.

The content described hereinabove is only a description of specific embodiments of the present invention, and the protection scope of the present invention is not limited thereto. Anything that a person skilled in the art can easily change or replace within the technical scope disclosed in the present invention is considered to be included in the protection scope of the present invention. The protection scope of the present invention is based on the protection scope of the claims.

1. A mattress control method, comprising the steps of:
obtaining biometric information of a user;
outputting vibration based on a sound source according to a comparison result between the biometric information and a threshold value; and
transmitting at least one of the biometric information, the threshold value, and mattress control information to an external controller,
wherein the biometric information includes at least immobility state duration information as sub-information, and the threshold value includes at least an immobility state duration threshold value, and
wherein the vibration is output when the immobility state duration information exceeds the immobility state duration threshold value, and is output based on external control information when the external control information is received from the external controller.

2. The mattress control method according to claim 1, wherein the outputting step includes the step of outputting a sound based on the sound source, and the sound is output when the immobility state duration information exceeds the immobility state duration threshold value.

3. The mattress control method according to claim 1 wherein the sound source is determined based on the beats per minute BPM of the sound source and the biometric information.

4. The mattress control method according to claim 2, wherein the biometric information further includes sleep biometric information, and sound output is stopped when it is determined that a user is in a sleep state based on the sleep biometric information.

5. A mattress, comprising:
a sensor for obtaining biometric information of a user;
a control unit for controlling a vibration unit according to a comparison result between the biometric information and a threshold value so that vibration is output based on a sound source; and
a communication interface for transmitting at least one of the biometric information, the threshold value, and mattress control information to an external controller,
wherein the biometric information includes at least immobility state duration information as sub-information, and the threshold value includes at least an immobility state duration threshold value, and
wherein the vibration is output when the immobility state duration information exceeds the immobility state duration threshold value, and is output based on external control information when the external control information is received from the external controller.

6. The mattress according to claim 5, wherein the control unit is configured to further control a speaker so that the speaker outputs a sound based on the sound source, and the sound is output when the immobility state duration information exceeds the immobility state duration threshold value.

7. The mattress according to claim 5, wherein the sound source is determined based on the beats per minute BPM of the sound source and the biometric information.

8. The mattress according to claim 6, wherein the biometric information further includes sleep biometric information, and the control unit stops sound output when it is determined that a user is in a sleep state based on the sleep biometric information.

9. The mattress control method according to claim 2, wherein the sound source is determined based on the beats per minute BPM of the sound source and the biometric information.
